(19) United States
(12) Patent Application Publication
(10) Pub. No.: US 2024/0380969 A1
(43) Pub. Date: Nov. 14, 2024

(54) IMAGING APPARATUS, CONTROL METHOD, AND CONTROL PROGRAM

(71) Applicant: FUJIFILM Corporation, Tokyo (JP)

(72) Inventors: Keita KAMEI, Saitama (JP); Takeharu Omata, Saitama (JP)

(73) Assignee: FUJIFILM Corporation, Tokyo (JP)

(21) Appl. No.: 18/653,951

(22) Filed: May 2, 2024

(30) Foreign Application Priority Data
May 12, 2023 (JP) 2023-079721

(51) Int. Cl. H04N 23/63; H04N 23/62; H04N 23/667

(52) U.S. Cl. CPC H04N 23/633; H04N 23/62; H04N 23/667

(57) ABSTRACT

An imaging apparatus including a main body having: a front surface on which an imaging lens is provided; a rear surface facing the front surface; and a top surface connecting the front surface and the rear surface, in which a release button, a display, and a plurality of switches are disposed on the top surface, the imaging apparatus including a processor configured to perform control of displaying, along a predetermined side forming a contour of the display, pieces of information indicating functions assigned to the plurality of switches side by side in a disposition order of the plurality of switches.

### CROSS-REFERENCE TO RELATED APPLICATIONS

This application claims priority from Japanese Application No. 2023-079721, filed on May 12, 2023, the entire disclosure of which is incorporated herein by reference.

### BACKGROUND

### Technical Field

The present invention relates to an imaging apparatus, a control method, and a program.

### Related Art

As an imaging apparatus such as a digital camera, for example, devices described in JP2002-344777A and JP2001-159777A below are known. JP2002-344777A discloses that a desired item is selected from among a plurality of items corresponding to a plurality of functions and is assigned to a predetermined switch, and the assigned item is displayed on a display on a rear surface of the imaging apparatus. JP2001-159777A discloses a configuration in which a liquid crystal display device having an external display function of displaying an imaging condition and the like is provided on a top surface of an imaging apparatus main body.

### SUMMARY

One embodiment according to the technique of the present disclosure provides an imaging apparatus, a control method, and a control program capable of realizing a quick operation while having multiple functions.

According to a first aspect of the present disclosure, there is provided an imaging apparatus including a main body having a front surface on which an imaging lens is provided, a rear surface facing the front surface, and a top surface connecting the front surface and the rear surface, in which a release button, a display, and a plurality of switches are disposed on the top surface. The imaging apparatus comprises a processor configured to perform control of displaying, along a predetermined side forming a contour of the display, pieces of information indicating functions assigned to the plurality of switches side by side in a disposition order of the plurality of switches.

In the first aspect, the side may extend in a direction intersecting a normal direction of a projection plane of the front surface and a normal direction of a projection plane of the top surface.

In the first aspect, the side, among a plurality of sides forming the contour of the display, may be relatively closer to the plurality of switches than other sides.

In the first aspect, a straight line that passes through a center of an entirety of the plurality of switches in a direction along the side and is orthogonal to the direction along the side may intersect the display.

In the first aspect, a straight line that passes through a center of an entirety of the plurality of switches in a direction along the side and is orthogonal to the direction along the side may intersect the release button.

In the first aspect, the plurality of switches may be sequentially disposed in parallel to a direction along the side.

In the first aspect, the display may have a rectangular shape.

In the first aspect, the main body may have a grip portion in which a part of the front surface protrudes, the top surface may include an upper surface of the grip portion and an upper surface other than the grip portion, and at least one of the plurality of switches may be disposed on the upper surface of the grip portion.

In the first aspect, the upper surface of the grip portion and the upper surface other than the grip portion may be surfaces that are both visible in a case of being viewed from a normal direction of a projection plane of the top surface.

In the first aspect, the upper surface of the grip portion may be inclined in a direction in which a height decreases from a side of the rear surface toward a side of the front surface, or a height of the upper surface of the grip portion may be lower than a height of the upper surface other than the grip portion on the side of the rear surface.

In the first aspect, the processor may be configured to perform control of displaying, on the display, a predetermined figure for each function as information indicating the function.

In the first aspect, the processor may be configured to perform control of displaying, on the display, the figure having a shape corresponding to a shape of each of the plurality of switches.

In the first aspect, the processor may be configured to perform control of displaying, on the display, the figure having a shape corresponding to a magnitude relationship between a length of the switch in a direction along the side and a length of the switch in a direction intersecting the direction along the side.

In the first aspect, the processor may be configured to perform, in a case where the switch is operated, control of causing a display form of the information indicating the function corresponding to the operated switch to be different.

In the first aspect, the switch may be a multifunctional key whose function to be assigned is changeable.

In the first aspect, the processor may be configured to receive, for each switch, selection of at least one of a plurality of predetermined functions to be assignable.

In the first aspect, the processor may be configured to specify, for each switch, the function that is selected a large number of times after the selection is received a plurality of times, and assign the specified function to the switch.

In the first aspect, the imaging apparatus may have a plurality of switchable operation modes, different functions for respective operation modes may be assigned to the switch, and the processor may be configured to perform control of displaying, on the display, the information indicating the function corresponding to the set operation mode.

According to a second aspect of the present disclosure, there is provided a control method executed by a computer, in an imaging apparatus including a main body having a front surface on which an imaging lens is provided, a rear surface facing the front surface, and a top surface connecting the front surface and the rear surface, in which a release button, a display, and a plurality of switches are disposed on the top surface. The control method comprises performing control of displaying, along a predetermined side of the display, pieces of information indicating functions assigned to the plurality of switches side by side in a disposition order of the plurality of switches.

According to a third aspect of the present disclosure, there is provided a control program causing a computer to execute a process, in an imaging apparatus including a main body having a front surface on which an imaging lens is provided, a rear surface facing the front surface, and a top surface connecting the front surface and the rear surface, in which a release button, a display, and a plurality of switches are disposed on the top surface. The control program comprises performing control of displaying, along a predetermined side of the display, pieces of information indicating functions assigned to the plurality of switches side by side in a disposition order of the plurality of switches.

According to the aspects, the imaging apparatus, the control method, and the control program of the present disclosure can realize a quick operation while having multiple functions.

### BRIEF DESCRIPTION OF THE DRAWINGS

FIG. 1 is a perspective view of a front surface side of an imaging apparatus according to one embodiment.

FIG. 2 is a perspective view of a rear surface side of the imaging apparatus according to one embodiment.

FIG. 3 is a plan view of a top surface of the imaging apparatus according to one embodiment.

FIG. 4 is a diagram for describing a relationship between normal directions of projection planes of a front surface and a top surface and a side of a top surface LCD.

FIG. 5 is a schematic diagram showing an example of a display of the top surface LCD and disposition of switches.

FIG. 6 is a block diagram showing an example of a hardware configuration of the imaging apparatus according to one embodiment.

FIG. 7 is a block diagram showing an example of a functional configuration of the imaging apparatus according to one embodiment.

FIG. 8 is a diagram showing an example of a setting screen displayed on the top surface LCD in a case where function assignment is performed on a multifunctional key.

FIG. 9 is a diagram showing an example of the setting screen displayed on the top surface LCD in a case where the function assignment is performed on the multifunctional key.

FIG. 10 is a diagram for describing the function assignment on the multifunctional key.

FIG. 11 is a diagram showing an example of a display change of the top surface LCD in a case where a multifunctional key is operated.

FIG. 12 is a diagram showing an example of the display change of the top surface LCD in a case where a multifunctional key is operated.

FIG. 13 is a diagram showing an example of the display change of the top surface LCD in a case where a multifunctional key is operated.

FIG. 14 is a flowchart showing an example of control processing.

FIG. 15 is a schematic diagram showing another example of the display of the top surface LCD and the disposition of the switches.

FIG. 16 is a schematic diagram showing another example of the display of the top surface LCD and the disposition of the switches.

FIG. 17 is a schematic diagram showing another example of the display of the top surface LCD and the disposition of the switches.

FIG. 18 is a schematic diagram showing another example of the display of the top surface LCD and the disposition of the switches.

FIG. 19 is a schematic diagram showing another example of the display of the top surface LCD and the disposition of the switches.

FIG. 20 is a schematic diagram showing another example of the display of the top surface LCD and the disposition of the switches.

FIG. 21 is a schematic diagram showing another example of the display of the top surface LCD and the disposition of the switches.

FIG. 22 is a schematic diagram showing another example of the display of the top surface LCD and the disposition of the switches.

FIG. 23 is a schematic diagram showing another example of the display of the top surface LCD and the disposition of the switches.

FIG. 24 is a schematic diagram showing another example of the display of the top surface LCD and the disposition of the switches.

FIG. 25 is a schematic diagram showing another example of the display of the top surface LCD and the disposition of the switches.

FIG. 26 is a diagram showing another example of the display change of the top surface LCD in a case where the multifunctional key is operated.

FIG. 27 is a diagram showing another example of the display change of the top surface LCD in a case where the multifunctional key is operated.

FIG. 28 is a diagram showing another example of the display change of the top surface LCD in a case where the multifunctional key is operated.

FIG. 29 is a diagram showing another example of the display change of the top surface LCD in a case where the multifunctional key is operated.

FIG. 30 is a diagram showing an example of the display of the top surface LCD in a case where there is a multifunctional key on which the function assignment is not performed.

FIG. 31 is a diagram showing an example of the display of the top surface LCD in a case where there is a multifunctional key to which a function assignment is not performed.

FIG. 32 is a diagram showing an example of the display of the top surface LCD.

FIG. 33 is an example of a list of functions that can be assigned to the multifunctional key

FIG. 34 is a schematic diagram showing a use aspect of the imaging apparatus according to one embodiment.

FIG. 35 is a schematic diagram showing a use aspect of the imaging apparatus according to one embodiment.

FIG. 36 is a schematic diagram showing a use aspect of the imaging apparatus according to one embodiment.

FIG. 37 is a schematic diagram showing a use aspect of the imaging apparatus according to one embodiment.

### DETAILED DESCRIPTION

### Outline of Technique of Present Disclosure

In recent years, in a digital camera such as a single-lens reflex camera or a mirrorless camera, a type of an imaging mode, characteristics of an imaging element, a type of a shutter, a setting item peculiar to a motion picture in a digital camera having a motion picture function, and the like have been made more multifunctional. On the other hand, there is a trade-off relationship between many functions and good operability. In a case where many functions are implemented, the operation is complicated and difficult to understand (that is, the operability deteriorates). In a case where the functions are organized in order to improve the operability, it is difficult to implement all functions that can be technically realized.

A multifunctional key is known as an example of an operation system that can handle operations related to these many functions. The multifunctional key allows a plurality of functions to be assigned to one key (an example of switch). However, from the nature of the multifunctional key, engraving or printing representing a function assigned to a key on a surface or the like of the key cannot be performed at a manufacturing stage. It is also difficult to provide a dedicated display or the like to display the function near the multifunctional key due to space limitation. For this reason, a user needs to check a setting screen or the like, which is displayed on a rear surface display, an electronic view finder (EVF), or the like, each time in order to check the function assigned to the key.

Further, a digital camera in which a plurality of multifunctional keys are disposed is also known in order to be able to handle more functions. With an increase in the number of functions and the number of keys in this manner, it is more difficult for the user to memorize the functions assigned to the multifunctional key. Even in a case where the user wants to use a desired function, the user may not immediately recognize which key needs to be operated to use the function, which may miss a shutter chance.

Further, it is considered that the multifunctional key is desired to be disposed near a release button in order to facilitate a quick operation while imaging is performed (that is, in a state where the camera is held such that the release button can be immediately pushed down). However, as described above, the user does not always memorize the functions assigned to the multifunctional key, and it is considered that there are many cases where the multifunctional key cannot be effectively utilized even in a case where the multifunctional key is disposed near the release button having good operability. In the related art, near the release button having good operability, it is common to dispose a single function key to which only one predetermined function is assigned.

Further, in many cases, function assignment processing to the multifunctional key and assigned function checking are performed by using the setting screen displayed on the rear surface display, the EVF, or the like. Since the release button is generally disposed on a top surface, in a case where the multifunctional key is disposed near the release button, the function assignment processing and the assigned function checking need to be performed in a state where the key is not included in a field of view of the user viewing the rear surface display or the EVF. That is, the user needs to perform the function assignment processing and the assigned function checking while comparing the top surface with the rear surface or the EVF, and it is difficult for the user to intuitively associate the multifunctional key with the function. For this reason, the disposition of the multifunctional key on the top surface in the digital camera in the related art is one factor of problems of the difficulty in memorizing the assigned function and the shutter chance missing.

From the above circumstances, the multifunctional key in the digital camera in the related art is often disposed near the rear surface display (for example, rear surface) and is rarely disposed near the release button (for example, top surface) having good operability. Further, even in a case where the multifunctional key is disposed near the release button (for example, top surface), it is not possible to easily perform the assigned function checking. For this reason, it is difficult to perform a quick operation while performing imaging, and there is a problem in operability.

The technique of the present disclosure provides an imaging apparatus capable of realizing a quick operation while having multiple functions for the problems. Hereinafter, the imaging apparatus according to one embodiment of the present disclosure will be described.

### Imaging Apparatus According to Present Embodiment

Hereinafter, one embodiment of the present disclosure will be described with reference to drawings.

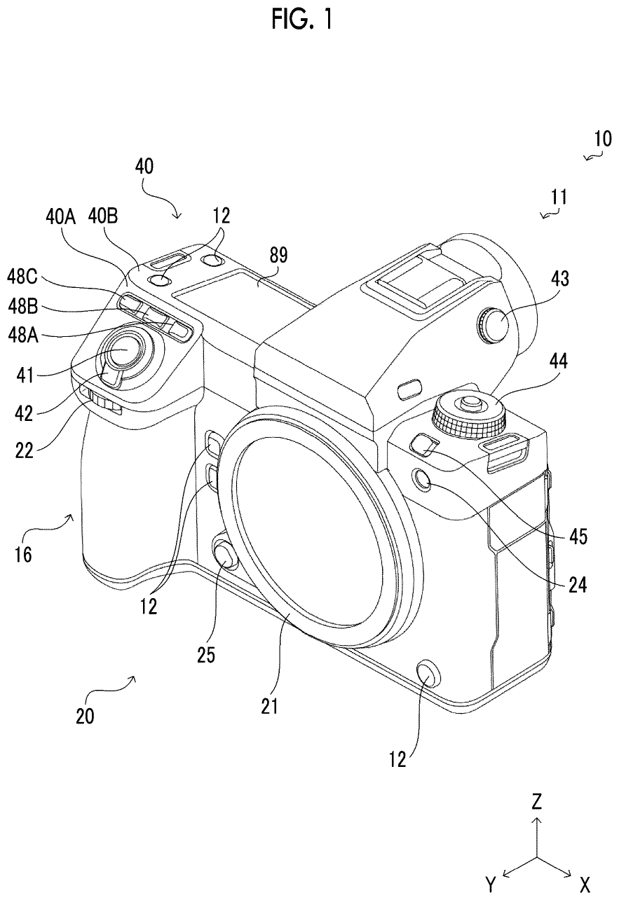

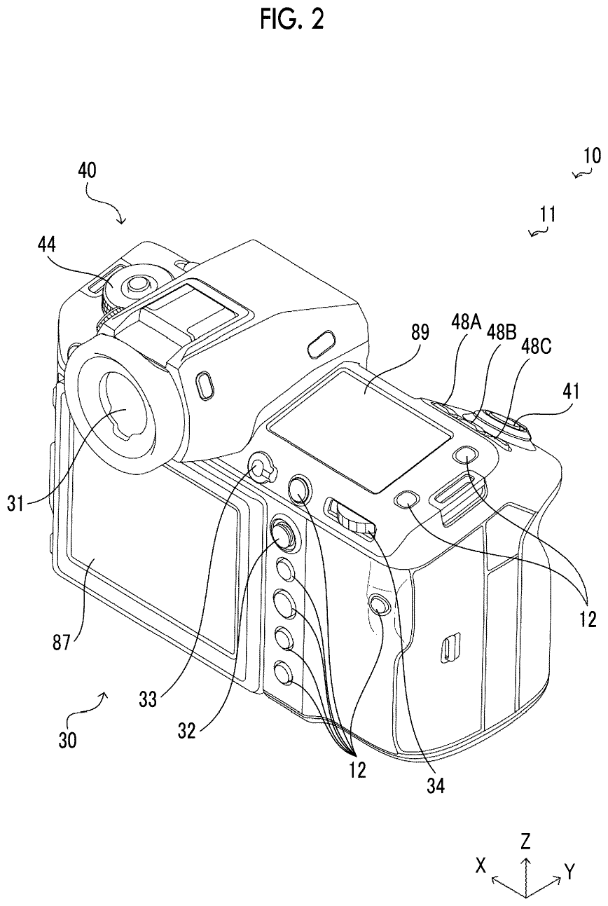

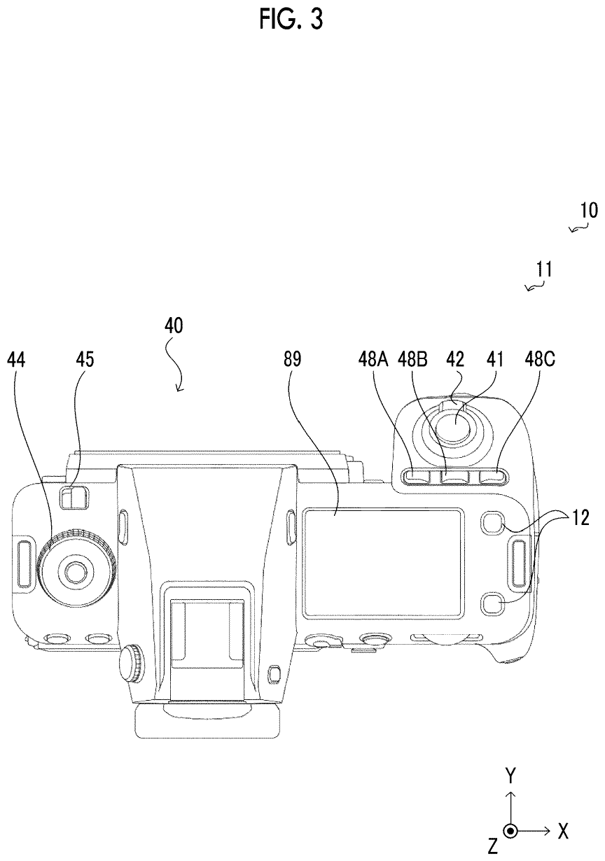

First, an example of an overall configuration of the imaging apparatus according to one embodiment of the present disclosure will be described with reference to FIGS. 1 to 3. FIGS. 1 to 3 are external views of a camera 10 as an example of the imaging apparatus according to one embodiment of the present disclosure. FIG. 1 is a perspective view of the camera 10 as viewed from a front surface 20 side, FIG. 2 is a perspective view of the camera 10 as viewed from a rear surface 30 side, and FIG. 3 is a plan view of the camera 10 as viewed from a top surface 40 side. In the following description, a direction from a rear surface 30 to a front surface 20 is referred to as a Y direction, a direction from a bottom surface toward a top surface 40 is referred to as a Z direction, and a direction orthogonal to the Y direction and the Z direction is referred to as an X direction.

The camera 10 is a so-called mirrorless type digital camera, and an imaging lens (not shown) is interchangeably and detachably attachable to the camera 10. The camera 10 comprises a camera body 11 as an example of a main body having the front surface 20 on which the imaging lens (not shown) is provided, the rear surface 30 facing the front surface 20, and the top surface 40 connecting the front surface 20 and the rear surface 30.

The front surface 20 is provided with an imaging opening on which light from an imaging target is incident, and a mount 21 is provided at a position corresponding to the imaging opening. The imaging lens (not shown) is mounted on the camera body 11 via the mount 21. Further, a front command dial 22, a plurality of buttons 12 to which respective functions are assigned, a lamp 24, a lens removal button 25, and the like are disposed on the front surface 20. The lamp 24 is used as, for example, an autofocus (AF) auxiliary light lamp, a self-timer lamp, and a tally lamp.

An EVF 31, a rear surface liquid crystal display (LCD) 87, the plurality of buttons 12 to which respective functions are assigned, a focus lever 32, a focus mode switching lever 33, a rear command dial 34, and the like are disposed on the rear surface 30.

A release button 41, a top surface LCD 89 as an example of a display, and a plurality of multifunctional keys 48A to 48C to which functions different from each other are assigned are disposed on the top surface 40. The plurality of multifunctional keys 48A to 48C are examples of a plurality of switches of the present disclosure, and are configured such that the functions assigned thereto are changeable. Hereinafter, in a case where the plurality of multifunctional keys 48A to 48C are not distinguished, the multifunctional keys 48A to 48C are simply referred to as “multifunctional key 48”.

Further, a power lever 42, the plurality of buttons 12 to which respective functions are assigned, a diopter adjustment dial 43, a mode change dial 44, a still picture-motion picture changeover switch 45, and the like are disposed on the top surface 40 of the camera body 11.

Further, the camera body 11 has a grip portion 16 in which a part of the front surface 20 protrudes. The grip portion 16 is a portion that is provided such that the user, who performs the imaging using the camera 10, can easily grip the camera body 11. The user basically uses one hand (right hand in many cases) that grips the grip portion 16 to operate the release button 41, the plurality of multifunctional keys 48, and the like.

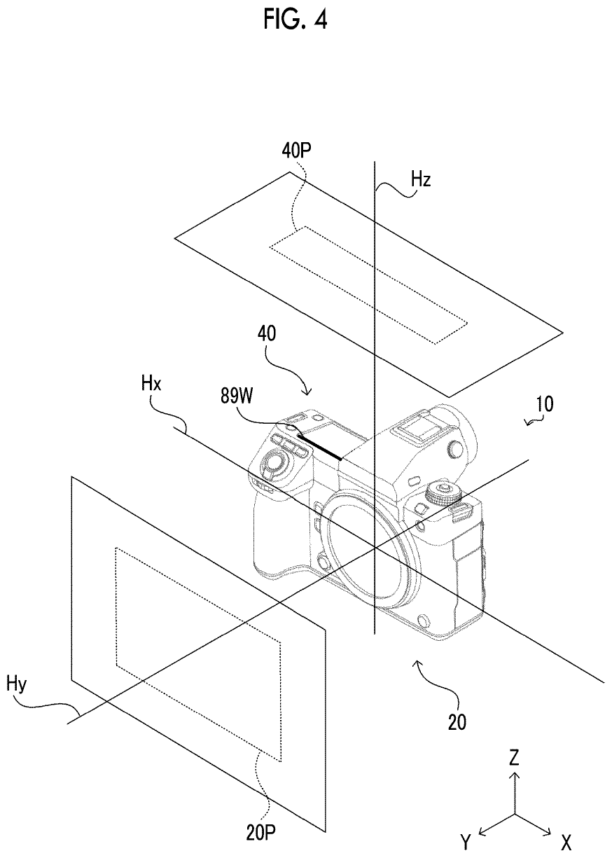

That is, the top surface 40 is configured by including an upper surface 40A of the grip portion 16 and an upper surface 40B other than the grip portion 16. Specifically, as shown in FIGS. 3 and 4, both the upper surface 40A of the grip portion 16 and the upper surface 40B other than the grip portion 16 are surfaces that can be visually recognized in a case of being viewed from a direction (Z direction) of a normal line Hz of a projection plane 40P of the top surface 40. FIG. 4 illustrates a projection plane 20P (XZ plane) of the front surface 20, a normal line Hy of the projection plane 20P, the projection plane 40P (XY plane) of the top surface 40, and the normal line Hz of the projection plane 40P, for the camera body 11.

At least one of the release button 41 or the plurality of multifunctional keys 48 is preferably disposed on the upper surface 40A of the grip portion 16 on the top surface 40 or around the upper surface 40A thereof. Specifically, at least one of the release button 41 or the plurality of multifunctional keys 48 is preferably present within a range in which the operation is possible with movement of a part of fingers of a hand gripping the grip portion 16 while the grip portion 16 is gripped (refer to FIGS. 34 to 37). In this case, the upper surface 40A of the grip portion 16 may be inclined in a direction in which a height decreases from the rear surface 30 side toward the front surface 20 side (Y direction), or a height thereof may be lower than that of the upper surface 40B other than the grip portion 16 on the rear surface 30 side. With such a configuration, it is easier to push down the release button 41 and the multifunctional key 48 with the hand gripping the grip portion 16, and it is possible to improve the operability. On the other hand, from a viewpoint of visibility and size reduction of the camera body 11, the top surface LCD 89 is preferably disposed on the upper surface 40B (upper surface of the camera body 11) other than the grip portion 16 of the camera body 11, not on the upper surface 40A of the grip portion 16.

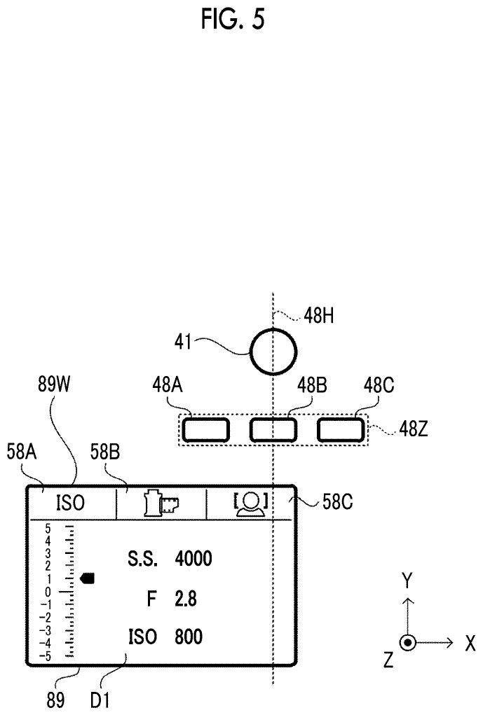

FIG. 5 shows an example of a condition screen D1 displayed on the top surface LCD 89 and a disposition relationship among the top surface LCD 89, the plurality of multifunctional keys 48A to 48C, and the release button 41. FIG. 5 is a plan view of a schematic configuration of the camera 10 as viewed from the top surface 40 side, and illustrates only a configuration required to be described. The condition screen D1 includes icons 58A to 58C indicating the functions assigned to the plurality of multifunctional keys 48A to 48C and imaging conditions such as a currently set shutter speed (S.S.), an F-Number, an ISO sensitivity, and exposure. Hereinafter, in a case where the plurality of icons 58A to 58C are not distinguished, the icons 58A to 58C are simply referred to as “icon 58”.

As shown in FIG. 5, the icons 58 indicating the functions assigned to the plurality of multifunctional keys 48 are displayed side by side in a disposition order of the plurality of multifunctional keys 48A to 48C, along a predetermined side (hereinafter referred to as “reference side 89W”) forming a contour of the top surface LCD 89. For example, it is assumed that a function of setting the ISO sensitivity is assigned to the multifunctional key 48A, a function of setting a film simulation is assigned to the multifunctional key 48B, and a function of turning on/off face detection is assigned to the multifunctional key 48C. In this case, the icon 58A representing a character “ISO”, the icon 58B representing a film, and the icon 58C representing the face detection are disposed side by side on the top surface LCD 89, in the disposition order (order of multifunctional keys 48A, 48B, and 48C) in a direction along the reference side 89W of the plurality of multifunctional keys 48.

Further, as shown in FIG. 4, the reference side 89W is preferably a side extending in a direction intersecting with a direction (Y direction) of the normal line Hy of the projection plane 20P of the front surface 20 and a direction (Z direction) of the normal line Hz of the projection plane 40P of the top surface 40. More preferably, the direction in which the reference side 89W extends intersects, in a range of 70 degrees to 115 degrees, with each of the direction (Y direction) of the normal line Hy of the projection plane 20P of the front surface 20 and the direction (Z direction) of the normal line Hz of the projection plane 40P of the top surface 40. Most preferably, the direction in which the reference side 89W extends is a direction in which a straight line Hx, which is orthogonal to each of the normal line Hy of the projection plane 20P of the front surface 20 and the normal line Hz of the projection plane 40P of the top surface 40, extends (that is, X direction). In other words, the direction in which the reference side 89W extends is a left-right direction as viewed from the user gripping the camera 10.

Further, as shown in FIG. 5, the reference side 89W is preferably a side that is relatively closer to the plurality of multifunctional keys 48 than other sides, among a plurality of sides forming the contour of the top surface LCD 89. With such a configuration, the user can easily visually recognize, at the same time, the icons 58 displayed on the top surface LCD 89 and the plurality of multifunctional keys 48. Therefore, it is possible to intuitively check the function assigned to each of the plurality of multifunctional keys 48.

Further, as shown in FIG. 5, a straight line 48H that passes through a center of an entirety 48Z of the plurality of multifunctional keys 48A to 48C in the direction (X direction) along the reference side 89W and is orthogonal to the direction along the reference side 89W preferably intersects the top surface LCD 89. That is, it is preferable that a deviation between the top surface LCD 89 and the plurality of multifunctional keys 48 in the direction along the reference side 89W is as small as possible. With such a configuration, the user can easily visually recognize, at the same time, the icons 58 displayed on the top surface LCD 89 and the plurality of multifunctional keys 48. Therefore, it is possible to intuitively check the function assigned to each of the plurality of multifunctional keys 48.

Further, as shown in FIG. 5, the straight line 48H that passes through the center of the entirety 48Z of the plurality of multifunctional keys 48A to 48C in the direction (X direction) along the reference side 89W and is orthogonal to the direction along the reference side 89W preferably intersects the release button 41. That is, it is preferable that a deviation between the plurality of multifunctional keys 48 and the release button 41 in the direction along the reference side 89W is as small as possible. With such a configuration, it is easy to operate the plurality of multifunctional keys 48 by bending and stretching a finger held for pushing down the release button 41, and it is possible to improve the operability.

Further, as shown in FIG. 5, it is preferable that the plurality of multifunctional keys 48 are sequentially disposed in parallel to the direction (X direction) along the reference side 89W. It should be noted that the term “parallel” as used herein is not limited to perfect parallelism and includes errors to an extent that is generally allowed in the technical field to which the technique of the present disclosure belongs. With such a configuration, it is easy to understand the association between the icons 58 displayed on the top surface LCD 89 and the plurality of multifunctional keys 48. Therefore, it is possible to intuitively grasp which function is assigned to which multifunctional key 48, and thus to improve the operability.

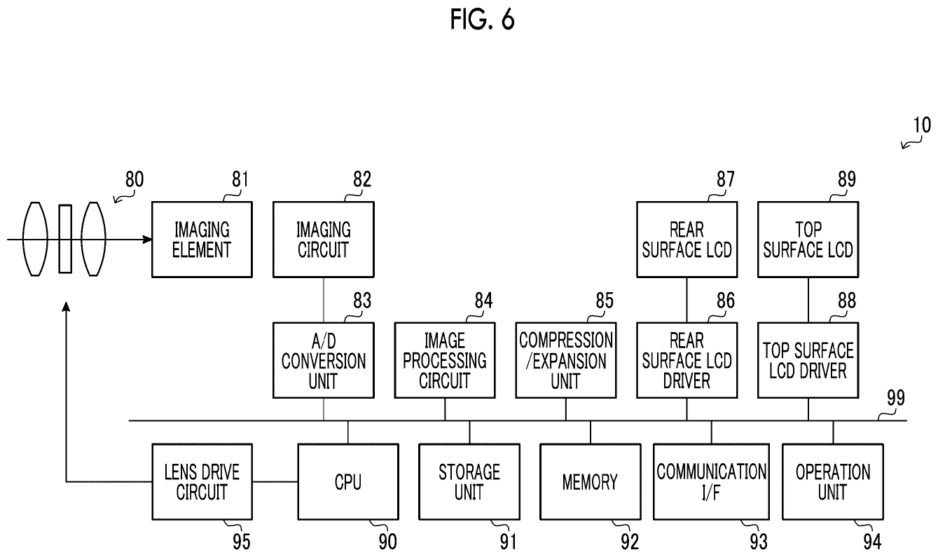

Next, an example of a hardware configuration of the camera 10 will be described with reference to FIG. 6. As shown in FIG. 6, the camera 10 includes a CPU 90, a non-volatile storage unit 91, a memory 92 as a temporary storage area, a communication I/F 93, and an operation unit 94. The communication I/F 93 performs wired or wireless communication with an external device. The operation unit 94 is various switches, buttons, dials, levers, and the like provided on the front surface 20, the rear surface 30, the top surface 40, and the like of the camera body 11 described above. Further, in a case where at least one of the rear surface LCD 87 or the top surface LCD 89 is a touch panel, at least one of the rear surface LCD 87 or the top surface LCD 89 may function as the operation unit 94.

The storage unit 91 is formed by a storage medium, such as a flash memory, and may be built into the camera 10 in advance or may be an attachable and detachable SD memory card or the like. The storage unit 91 stores various control programs in the camera 10. The CPU 90 controls the entire camera 10 by reading out the control program from the storage unit 91, loading the control program into the memory 92, and executing the loaded control program. Further, the CPU 90 performs drive control of an imaging lens 80 via a lens drive circuit 95.

Further, the camera 10 comprises an imaging element 81, an imaging circuit 82, an A/D conversion unit 83, an image processing circuit 84, and a compression/expansion unit 85. The imaging element 81 is a charge coupled device (CCD), a complementary metal oxide semiconductor (CMOS), or the like that outputs an electric signal according to a subject image formed by the imaging lens 80. The imaging circuit 82 generates an analog image signal based on the electric signal output from the imaging element 81, and the analog image signal is converted into a digital image signal by the A/D conversion unit 83. The A/D conversion unit 83 temporarily stores the converted digital image signal in the memory 92. The image processing circuit 84 performs various types of image processing, such as conversion of color information and conversion of the number of pixels, on the digital image signal temporarily stored in the memory 92. The compression/expansion unit 85 performs, for example, joint photographic experts group (JPEG) compression on the digital image signal subjected to various types of image processing by the image processing circuit 84, and stores the JPEG data in the storage unit 91.

Further, the camera 10 comprises the rear surface LCD 87, a rear surface LCD driver 86 that drives the rear surface LCD 87, the top surface LCD 89, and a top surface LCD driver 88 that drives the top surface LCD 89. Each of the rear surface LCD 87 and the top surface LCD 89 is a dot matrix type liquid crystal display, and is configured to display any image, figure, and character. In the rear surface LCD 87 and the top surface LCD 89, the rear surface LCD 87 is larger in size and has a higher resolution.

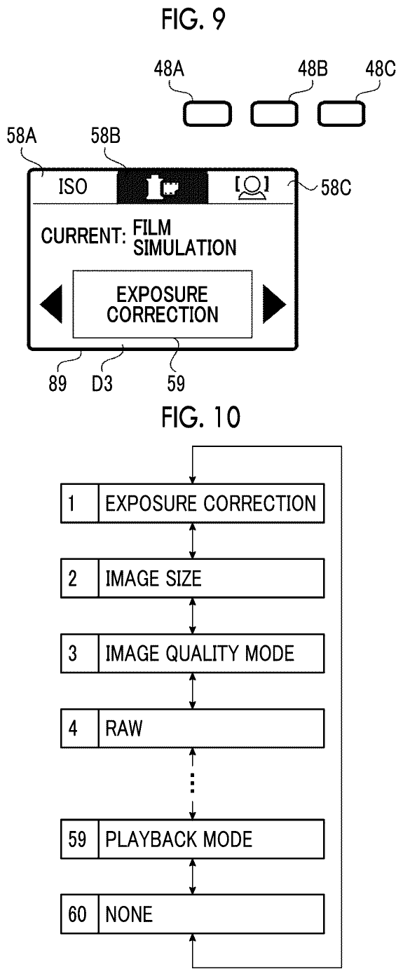

The rear surface LCD 87 displays, for example, a captured image and information regarding various menu operations and setting changes. As shown in FIG. 5, the top surface LCD 89 displays the icons 58 indicating the functions assigned to the plurality of multifunctional keys 48 and various imaging conditions that are currently set. Further, the top surface LCD 89 displays the setting screen in a case where the function assignment of the multifunctional key 48 is changed (refer to FIGS. 8 and 9). The rear surface LCD 87 is preferably a color LCD since the captured image is displayed, while the top surface LCD 89 may be a monochrome LCD that is sufficient for displaying the icons 58, various imaging conditions, and the like.

The A/D conversion unit 83, the image processing circuit 84, the compression/expansion unit 85, the rear surface LCD driver 86, the top surface LCD driver 88, the CPU 90, the storage unit 91, the memory 92, the communication I/F 93, and the operation unit 94 are connected to each other via a bus 99, such as a system bus and a control bus, in a manner capable of exchanging various types of information with each other.

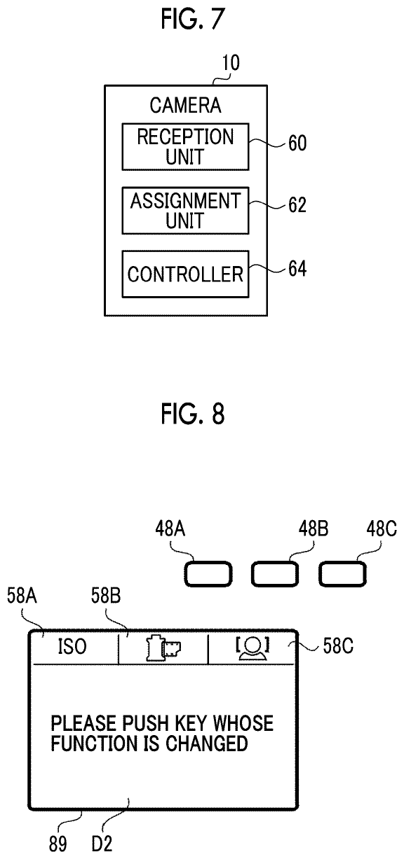

Next, an example of a functional configuration of the camera 10 will be described with reference to FIG. 7. As shown in FIG. 7, the camera 10 includes a reception unit 60, an assignment unit 62, and a controller 64. With execution of the control program stored in the storage unit 91 by the CPU 90, the CPU 90 functions as the reception unit 60, the assignment unit 62, and the controller 64.

The reception unit 60 receives selection of at least one of a plurality of assignable functions set in advance for each multifunctional key 48. Specifically, first, the reception unit 60 controls the top surface LCD 89 to display a setting screen D2 as shown in FIG. 8 and waits until any one of the multifunctional keys 48A to 48C is pushed down. The user pushes down any one of the multifunctional keys 48A to 48C for which the user desires to change the function assignment. For example, it is assumed that the user pushes down the multifunctional key 48B to which the function of setting the film simulation is assigned at a current point in time.

Next, the reception unit 60 controls the top surface LCD 89 to display a setting screen D3 as shown in FIG. 9. In the setting screen D3, a color of the icon 58B corresponding to the pushed-down multifunctional key 48B and a background color are changed to be inverted in black and white to make the icon 58B conspicuous. A function name “film simulation” assigned to the multifunctional key 48B at a current point in time is displayed in an item of “current” on the setting screen D3.

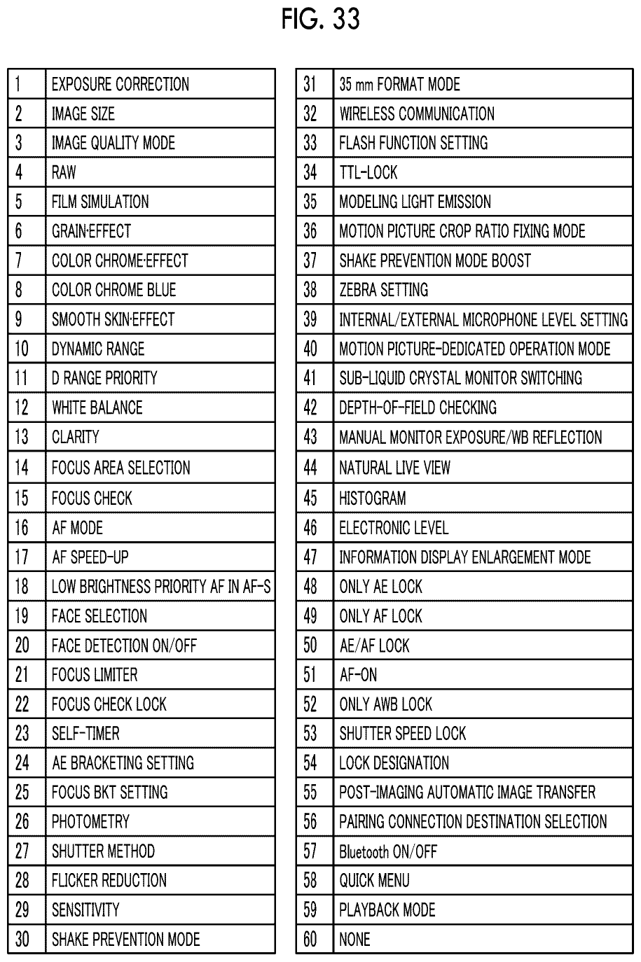

Further, another function name “exposure correction” that can be assigned to the multifunctional key 48B is displayed in a display field 59 at a lower part of the setting screen D3. Other function names that can be assigned to the multifunctional key 48B are displayed while being sequentially switched as shown in FIG. 10 with operation of the operation unit 94 (for example, the front command dial 22 and the rear command dial 34). Functions that can be assigned to the multifunctional key 48B shown in FIG. 10 are only some of the functions, and a detailed description thereof will be described below (refer to FIG. 33).

For example, in a case where the front command dial 22 is rotated in a right direction, switching is performed in an order of “exposure correction”, “image size”, “image quality mode”, and the like. On the other hand, in a case where the front command dial 22 is rotated in a left direction, the switching is performed in an order of “exposure correction”, “none”, “playback mode”, and the like. The user operates the operation unit 94 (for example, the multifunctional key 48B of which the function assignment is being changed) in a state where the desired function is displayed in the display field 59 of the setting screen D3 to decide the function assigned to the multifunctional key 48B.

The assignment unit 62 assigns the decided function to the multifunctional key 48B and stores the content in the non-volatile storage unit 91. As described above, different functions are assigned to the respective multifunctional keys 48. In this manner, with the display of the setting screen D3 for the function assignment of the multifunctional key 48 on the top surface LCD 89, the user can simultaneously bring the multifunctional key 48 and the setting screen D3 into the field of view in a case where the user views the top surface 40. Therefore, it is possible to perform an intuitive operation.

Since the functions assigned to the multifunctional key 48 are stored in the non-volatile storage unit 91 as described above, even in a case where a power of the camera 10 is turned off, the content of the function assignment can be maintained in a case where the camera 10 is started next. On the other hand, the content of the function assignment may not be maintained, and default functions may be reassigned in a case where the camera 10 is started next after the power is turned off. The user may be able to select whether to maintain the content of the function assignment or return the content to a default content in a case where the power is turned on and off.

Further, in a case where the function assignment is repeatedly performed, the camera 10 may have a learning function of preferentially assigning a function having a high use frequency. Specifically, the reception unit 60 is assumed to receive the selection of the function assigned to each of the multifunctional keys 48 a plurality of times. Thereafter, the assignment unit 62 may specify a function that is selected a large number of times for each multifunctional key 48, and assign the specified function to the multifunctional key 48.

Further, for example, in a case where the function names that can be assigned to the multifunctional keys 48 are displayed while being sequentially switched on the setting screen D3 of FIG. 9, the functions may be displayed in descending order of the number of times of selection. That is, with the operation of the operation unit 94 (for example, the front command dial 22 and the rear command dial 34) on the setting screen D3, the function names may be displayed in descending order of the number of times of selection, not a predetermined order as in FIG. 10.

As shown in FIG. 5, the controller 64 performs control of displaying, along the predetermined reference side 89W of the top surface LCD 89, pieces of information indicating the functions assigned to the plurality of multifunctional keys 48 side by side in the disposition order of the plurality of multifunctional keys 48. Specifically, the controller 64 performs control of displaying, on the top surface LCD 89, a predetermined figure (for example, icon 58) for each function as the information indicating the functions assigned to the plurality of multifunctional keys 48. The figure referred to here is not limited to a pattern such as the icons 58B and 58C, but may be configured by including only a character, such as the icon 58A.

Further, the controller 64 preferably performs control of displaying, on the top surface LCD 89, a figure having a shape corresponding to a shape of each of the plurality of multifunctional keys 48. Specifically, the controller 64 preferably performs control of displaying, on the top surface LCD 89, a figure having a shape according to a magnitude relationship between a length of the multifunctional key 48 in the direction (X direction) along the reference side 89W on which the figures (icons 58) are disposed side by side and a length of the multifunctional key 48 in the direction (Y direction) intersecting with the direction along the reference side 89W. That is, in a plane (XY plane) consisting of the direction (X direction) along the reference side 89W and the direction (Y direction) intersecting the reference side 89W, an aspect ratio of the multifunctional key 48 and an aspect ratio of the icon 58 are preferably in the same ratio.

For example, as shown in FIG. 5, in a case where the multifunctional key 48 is horizontally long, it is preferable that the icon 58 is also horizontally long. Further, for example, in a case where the multifunctional key 48 is circular, it is preferable that the icon 58 is also circular. In this manner, with the setting of the shape of the icon 58 to a shape imitating the multifunctional key 48, it is easy for the user to intuitively grasp which key corresponds to the function displayed on the top surface LCD 89. Further, even though the button 12 other than the multifunctional keys 48 is disposed on the top surface 40 as shown in FIG. 3, a possibility of misunderstanding that the key corresponding to the function displayed on the top surface LCD 89 is the button 12 can be reduced.

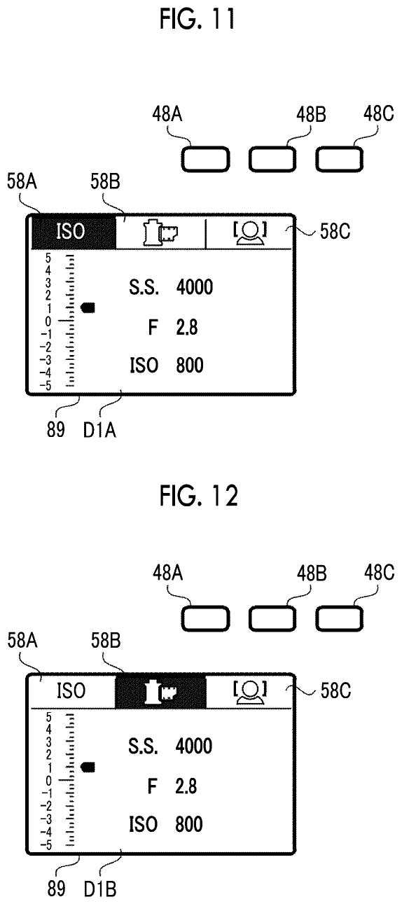

Further, in a case where the multifunctional key 48 is operated, the controller 64 may perform control of causing a display form of the information (for example, the icon 58) indicating the function corresponding to the operated multifunctional key 48 to be different. FIGS. 11 to 13 show a state in which the condition screen D1 (refer to FIG. 5) displayed on the top surface LCD 89 is changed by the operations of the respective multifunctional keys 48.

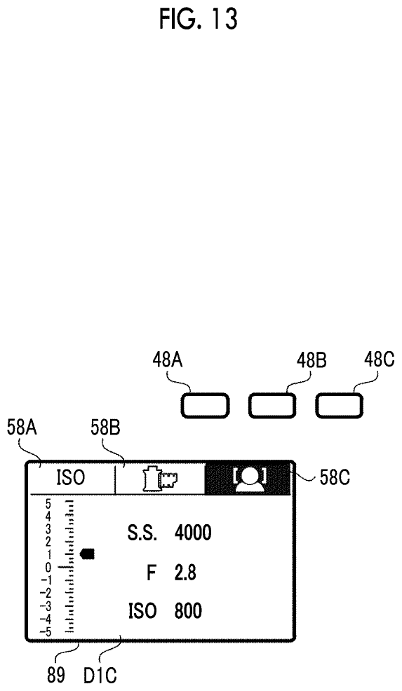

FIG. 11 shows a condition screen DIA in a case where the multifunctional key 48A is operated, FIG. 12 shows a condition screen DIB in a case where the multifunctional key 48B is operated, and FIG. 13 shows a condition screen DIC in a case where the multifunctional key 48C is operated. As shown in FIGS. 11 to 13, the controller 64 may invert the color of the icon 58 corresponding to the operated multifunctional key 48 and the background color in black and white to make the icon 58 conspicuous.

Further, in a case where the multifunctional key 48 is operated, the controller 64 reads out which function is assigned to the operated multifunctional key 48 from the storage unit 91 and controls each functional unit such that the readout function operates.

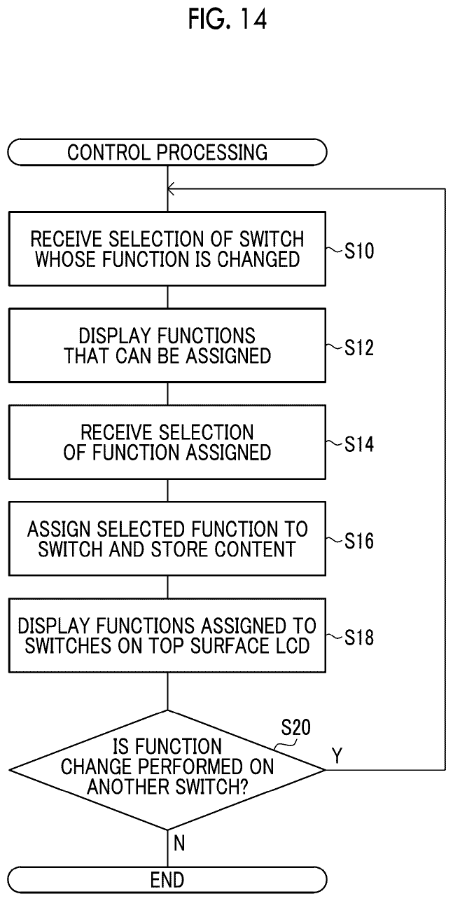

Next, an operation of the camera 10 according to the present embodiment will be described with reference to FIG. 14. In the camera 10, the CPU 90 executes the control program to execute control processing shown in FIG. 14. The control processing is executed, for example, in a case where the user gives an instruction to start the execution via the operation unit 94.

In step S10, the reception unit 60 receives the selection of the switch whose function assignment is changed. Specifically, the reception unit 60 performs control of displaying the setting screen D2 on the top surface LCD 89 (refer to FIG. 8) and waits until any one of the multifunctional keys 48 is pushed down. In step S12, the reception unit 60 performs control of displaying, on the top surface LCD 89, the functions that can be assigned to the switch (multifunctional key 48) selected in step S10. Specifically, the reception unit 60 performs control of displaying the setting screen D3 on the top surface LCD 89 (refer to FIG. 9) and sequentially switches the functions to be displayed on the setting screen D3 in response to the operation of the operation unit 94.

In step S14, the reception unit 60 receives the selection of the function assigned to the switch (multifunctional key 48) selected in step S10. Specifically, the user selects the function desired to be assigned to the switch (multifunctional key 48) selected in step S10 while checking the setting screen D3 displayed on the top surface LCD 89 in step S12. In step S16, the assignment unit 62 assigns the function decided in step S14 to the switch (multifunctional key 48) selected in step S10, and stores the content in the storage unit 91.

In step S18, the controller 64 performs the control of displaying, along the predetermined reference side 89W of the top surface LCD 89, the pieces of information (icons 58) indicating the functions assigned to the plurality of switches side by side in the disposition order of the plurality of switches (multifunctional keys 48).

In step S20, the reception unit 60 determines whether or not the function assignment is changed for another switch different from the switch selected in step S10. Specifically, the reception unit 60 performs control of displaying, on the top surface LCD 89, a screen to ask whether to change the function assignment for another switch, and waits until the user's instruction is received. In a case where affirmative determination is made in step S20, the processing returns to step S10. In a case where negative determination is made in step S20, the present control processing is ended.

As described above, the imaging apparatus according to one aspect of the present disclosure comprises the main body including the front surface on which the imaging lens is provided, the rear surface facing the front surface, and the top surface connecting the front surface and the rear surface. Further, the release button, the display, and the plurality of switches are disposed on the top surface. Further, the imaging apparatus comprises the processor that performs the control of displaying, along the predetermined side forming the contour of the display, the pieces of information indicating the functions assigned to the plurality of switches side by side in the disposition order of the plurality of switches.

That is, in the camera 10 according to the present embodiment, all of the release button 41, the multifunctional keys 48, and the top surface LCD 89 that displays the pieces of information (icons 58) indicating the functions of the multifunctional keys 48 are displayed on the top surface 40. With the implementation of the release button 41 and the multifunctional key 48 on the same top surface 40, the multifunctional key 48 can be operated with the finger held for pushing down the release button 41, and thus it is possible to improve the operability.

Further, with the display, on the top surface LCD 89, of the function of the multifunctional key 48 that is multifunctional, which makes the assigned function difficult to be memorized, it is possible to reduce movement of a visual line at the time of checking. Therefore, it is possible to suppress the occurrence of the shutter chance missing. Further, with the display of the icons 58 side by side on the top surface LCD 89 in the disposition order of the multifunctional keys 48, it is possible to intuitively grasp a correspondence relationship between the multifunctional keys 48 and the icons 58, which contributes to the realization of a quick operation.

Further, according to various researches in human engineering, in a case where different matters are memorized in association with each other, it is known that an associated result can be memorized strongly and for a long time in a case where the different matters are captured in the same field of view as compared with a case where the different matters are captured in different fields of view. With the camera 10 according to the present embodiment, the multifunctional keys 48 and the icons 58 displayed on the top surface LCD 89 are configured to be simultaneously visible, which is conceivable to contribute to the improvement of the operability from the viewpoint of human engineering.

In this manner, with the camera 10 according to the present embodiment, a quick operation is realized while being multifunctional with contrivance of the disposition relationship between the release button 41, the multifunctional keys 48, and the top surface LCD 89 and the display content of the top surface LCD 89.

In the above embodiment, the aspect has been described in which the camera 10 is the so-called mirrorless type digital camera and the imaging lens (not shown) is interchangeably and detachably attachable to the camera 10. However, the technique of the present disclosure is not limited thereto. The imaging apparatus of the present disclosure may be a so-called lens-fixed type camera comprising a main body having a front surface on which an imaging lens that is not interchangeable and detachable is provided, a rear surface facing the front surface, and a top surface connecting the front surface and the rear surface.

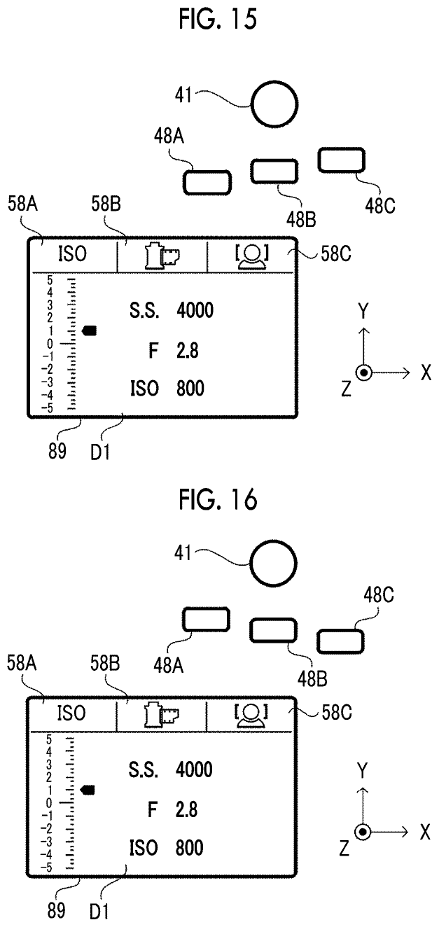

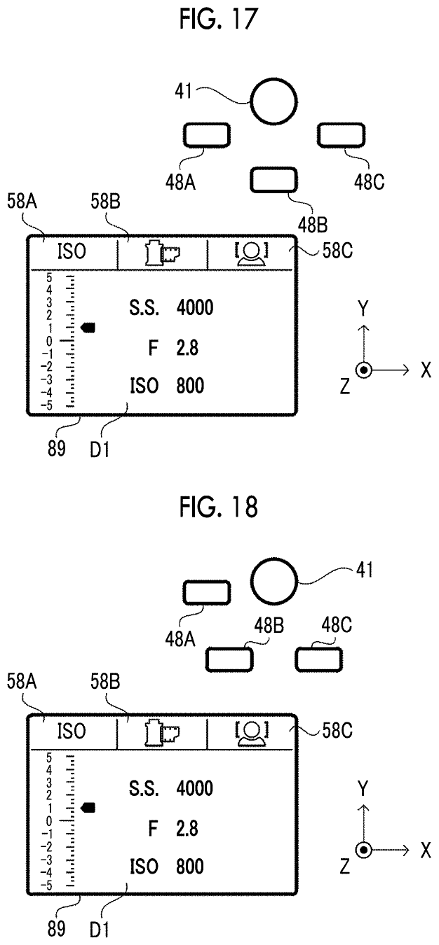

Further, in the above embodiment, the aspect has been described in which the three rectangular multifunctional keys 48A to 48C are sequentially disposed in parallel to the direction (X direction) along the reference side 89W of the top surface LCD 89. However, the technique of the present disclosure is not limited thereto. Hereinafter, modification examples of the condition screen D1 displayed on the top surface LCD 89 and the disposition relationship between the top surface LCD 89, the plurality of multifunctional keys 48, and the release button 41 will be described with reference to FIGS. 15 to 23. Since an illustration method of FIGS. 15 to 23 is the same as that in FIG. 5, some redundant descriptions will be omitted.

For example, as shown in FIGS. 15 to 17, the plurality of multifunctional keys 48A to 48C may be disposed while being shifted in the direction (Y direction) orthogonal to the direction (X direction) along the reference side 89W of the top surface LCD 89 on which the icons 58 are displayed along. Further, for example, as shown in the multifunctional keys 48A and 48B of FIG. 18, the multifunctional keys 48 may partially overlap in the direction (X direction) along the reference side 89W.

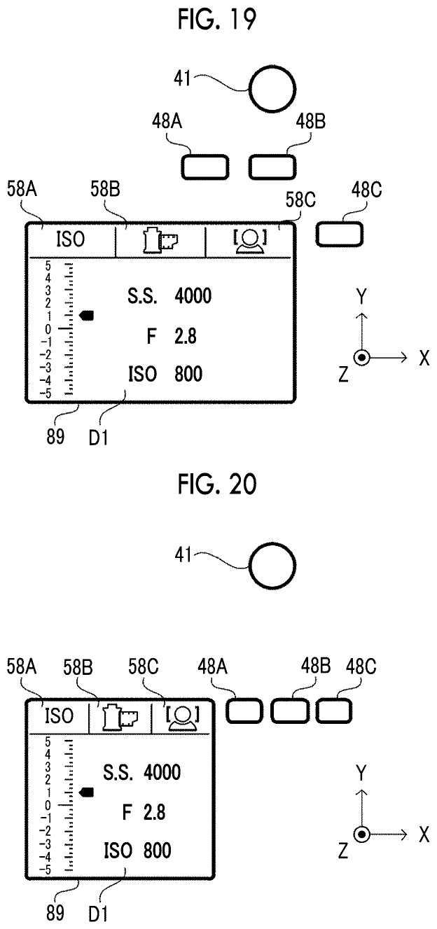

Further, for example, as shown in FIGS. 19 and 20, at least a part of the plurality of multifunctional keys 48 may be disposed near the top surface LCD 89, not near the release button 41. That is, the multifunctional key 48 may be disposed on the upper surface 40B other than the grip portion 16, not on the upper surface 40A of the grip portion 16.

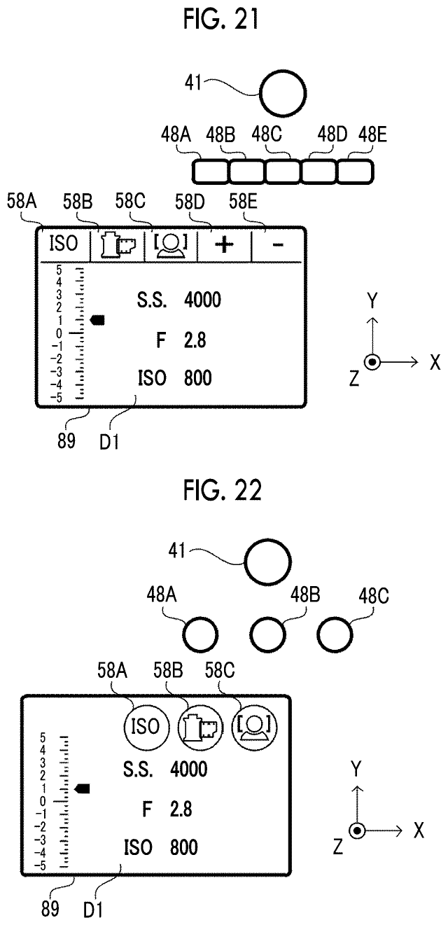

Further, for example, the number of a plurality of the multifunctional keys 48 is not limited to three, may be two or more, and may be five as shown in FIG. 21. In this case, the number of icons 58A to 58E displayed on the top surface LCD 89 also corresponds to the number of the multifunctional keys 48A to 48E.

Further, for example, the shapes of the plurality of multifunctional keys 48 are not limited to the rectangular shape, and may be a circular shape as shown in FIG. 22. In this case, it is preferable that the shape of the icon 58 displayed on the top surface LCD 89 is also circular in correspondence with the shape of the multifunctional key 48.

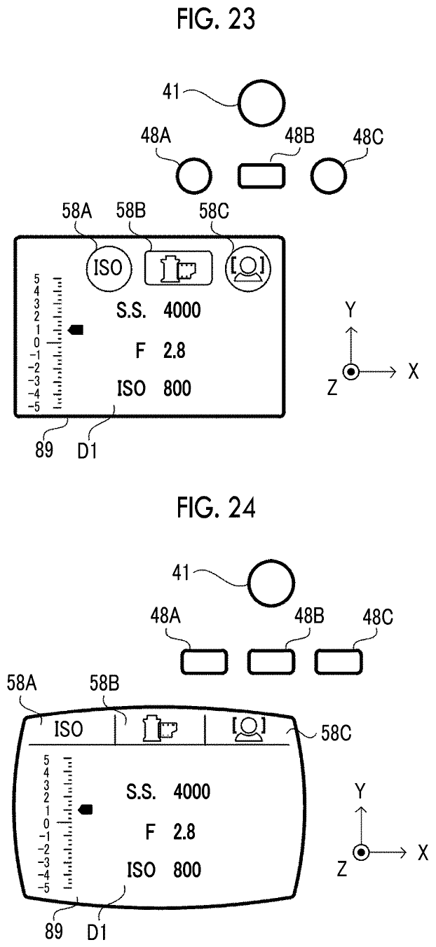

Further, for example, as shown in FIG. 23, the shapes of the plurality of multifunctional keys 48 may not be the same or may be a combination of different shapes. In this case, it is preferable that the shapes of the icons 58 displayed on the top surface LCD 89 correspond to the shapes of the respective multifunctional keys 48.

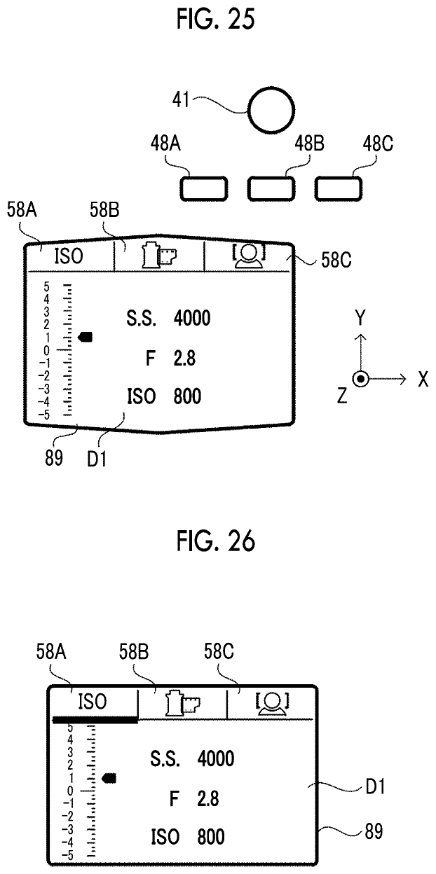

Further, in the above embodiment, the aspect has been described in which the top surface LCD 89 has the rectangular shape. However, the technique of the present disclosure is not limited thereto, and the top surface LCD 89 may have a polygonal shape. Further, the top surface LCD 89 is not limited to a perfect rectangle, and may be a rectangle deformed to an extent that is generally allowed in the technical field to which the technique of the present disclosure belongs. For example, as shown in FIG. 5 and the like, corner portions of the contour of the top surface LCD 89 may be rounded. Further, for example, as shown in FIG. 24, the side forming the contour of the top surface LCD 89 may be curved in a range close to parallel. Further, for example, as shown in FIG. 25, the side forming the contour of the top surface LCD 89 may be bent in a range close to parallel.

Further, in the above embodiment, the aspect has been described in which the color of the icon 58 displayed on the top surface LCD 89 and the background color are inverted in black and white in a case where the multifunctional key 48 is operated. However, the technique of the present disclosure is not limited thereto. It is sufficient that the icon 58 is conspicuous with the change in the display form of the icon 58 corresponding to the operated multifunctional key 48.

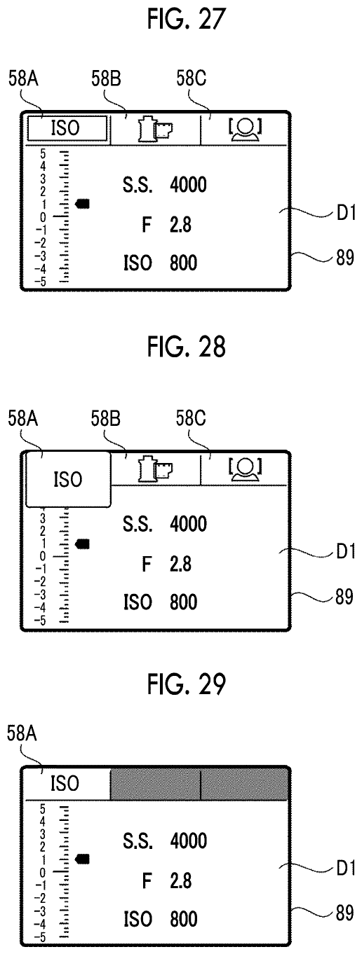

For example, as shown in FIG. 26, in a case where the multifunctional key 48A is operated, a line may be added to a lower part of the corresponding icon 58A. Further, for example, as shown in FIG. 27, in a case where the multifunctional key 48A is operated, the corresponding icon 58A may be framed. Further, for example, as shown in FIG. 28, in a case where the multifunctional key 48A is operated, the corresponding icon 58A may be displayed in an enlarged manner. Further, for example, in a case where the multifunctional key 48A is operated, sizes of the character and/or the pattern included in the icon 58A may not be changed, and only a frame surrounding the icon 58A may be displayed in an enlarged manner. Further, for example, in a case where the multifunctional key 48A is operated, the character and/or the pattern included in the icon 58A may be displayed in an enlarged manner, and a size of the frame surrounding the icon 58A may not be changed. Further, for example, as shown in FIG. 29, in a case where the multifunctional key 48A is operated, only the corresponding icon 58A may be displayed, and the other icons may not be displayed or may be grayed out.

Further, in the above embodiment, the aspect has been described in which the reception unit 60 performs the control of displaying, on the top surface LCD 89, the setting screens D2 and D3 for changing the function assignment of the multifunctional keys 48. However, the technique of the present disclosure is not limited thereto. For example, the reception unit 60 may perform control of displaying, on the rear surface LCD 87 instead of the top surface LCD 89, the setting screens D2 and D3 for changing the function assignment of the multifunctional keys 48.

Further, in the above embodiment, the camera 10 may have a plurality of switchable operation modes such as a still picture mode, a motion picture mode, a playback mode, and a setting mode. In this case, the multifunctional key 48 may be assigned different functions for each operation mode. For example, in the still picture mode and the motion picture mode, a function used for imaging may be assigned to the multifunctional key 48. In the playback mode, a function used for playback may be assigned to the multifunctional key 48. In this case, the controller 64 performs the control of displaying, on the top surface LCD 89, the information (for example, the icon 58) indicating the function corresponding to the set operation mode.

Further, in the above embodiment, the aspect has been described in which the user can randomly change the function assignment of the multifunctional key 48. However, the technique of the present disclosure is not limited thereto, and anything may be employed, as the multifunctional key 48, to which the plurality of functions are assigned. For example, even though the user cannot randomly select the function assignment, the multifunctional key 48 includes anything to which a different function is assigned for each operation mode.

Further, in the above embodiment, the aspect has been described in which the number of functions assigned simultaneously to one multifunctional key 48 is one. However, the technique of the present disclosure is not limited thereto. For example, the plurality of functions may be simultaneously assigned to one multifunctional key 48 by causing the functions to be operated according to a pushing-down method of one multifunctional key 48 to be different. For example, different functions may be operated according to a length of a time for which the multifunctional key 48 is pushed down, a depth of the pushing-down, and the number of times the multifunctional key 48 is continuously pushed down (single click, double click, or the like). In this case, the user may be able to randomly change the function assignment for each pushing-down method of the multifunctional key 48.

Further, in the above embodiment, the aspect has been described in which the multifunctional keys 48 are mutually independent switches. However, the technique of the present disclosure is not limited thereto. For example, a two-pole or three-pole seesaw switch (also referred to as a rocker switch) may be used as the multifunctional key 48, and a different function may be assigned to each pole. That is, one seesaw switch may be regarded as an integration of a plurality of multifunctional keys.

Further, in the above embodiment, the aspect has been described in which the plurality of multifunctional keys 48A to 48C to which a plurality of functions can be respectively assigned are used as an example of the plurality of switches according to the present disclosure. However, the technique of the present disclosure is not limited thereto. For example, as the plurality of switches, a multifunctional key to which a plurality of functions can be assigned and a single function key to which a certain fixed function is assigned may be used in combination.

For example, among the three multifunctional keys 48A to 48C described in the above embodiment, the multifunctional keys 48B and 48C may be replaced with single function keys to which fixed functions are assigned. In this case, on the condition screen D1 (refer to FIG. 5) displayed on the top surface LCD 89, the display of the icon 58A corresponding to the multifunctional key 48A may be changed by a change in the assigned function, and the fixed functions assigned to the icons 58B and 58C, which correspond to the single function keys replacing the multifunctional keys 48B and 48C, may be always displayed.

Further, in the above embodiment, the aspect has been described in which the multifunctional key 48 is pushed down to assign the function to be operated and the assigned function is displayed on the top surface LCD 89. However, the technique of the present disclosure is not limited thereto. For example, the functions may not be assigned to some of the plurality of switches.

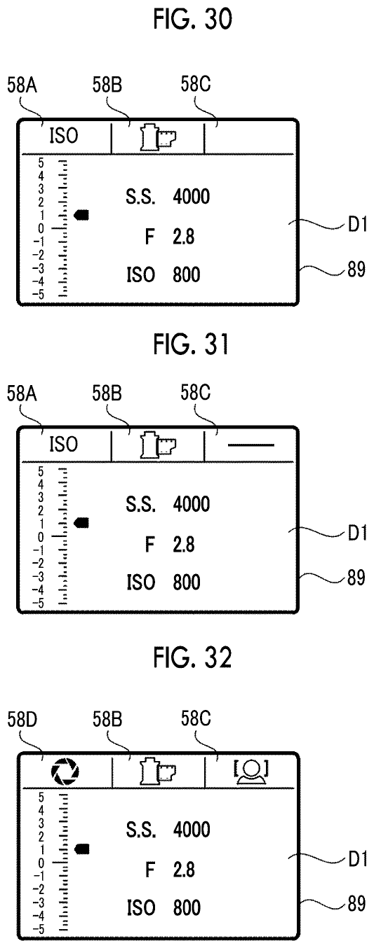

For example, among the three multifunctional keys 48A to 48C described in the above embodiment, the functions may be assigned to the multifunctional keys 48A and 48B, and the function may not be assigned to the multifunctional key 48C (that is, no function may be operated even in a case where the multifunctional key 48C is pushed down). In this case, the fact indicating that the function is not assigned may be displayed, on the top surface LCD 89, as the icon 58C corresponding to the multifunctional key 48C to which the function is not assigned, for example, as shown in FIG. 30 or 31. On the condition screen D1 of FIG. 30, the icon 58C corresponding to the multifunctional key 48C to which the function is not assigned is displayed blank. On the condition screen D1 of FIG. 31, a horizontal line is displayed as the icon 58C corresponding to the multifunctional key 48C to which the function is not assigned.

Further, in the above embodiment, for at least a part of the plurality of multifunctional keys 48, it may be possible to temporarily disable the function to be operated by the pushing-down. For example, the camera 10 may have the operation unit 94 (for example, switch for function lock) for disabling the function assigned to at least a part of the multifunctional keys 48. With an operation of the operation unit 94, the function assignment of the multifunctional key 48 may be temporarily disabled (that is, nothing may be performed even in a case where the multifunctional key 48 is pushed down). Further, with the operation of the function lock switch again, the function assignment of the multifunctional key 48 may be enabled again. In this case, while the function assignment is disabled, the fact indicating that the function is not assigned may be displayed on the top surface LCD 89, for example, as in the icon 58C of FIG. 30 or FIG. 31.

Further, in the above embodiment, the aspect has been described in which the figure such as the icon 58A configured by including only the character is displayed on the top surface LCD 89 as the information indicating the function assigned to the multifunctional key 48. However, the technique of the present disclosure is not limited thereto. For example, as shown in icons 58B to 58D in FIG. 32, a figure including a pattern (pictogram) may be used as the information indicating the function assigned to the multifunctional key 48. The icon 58D is a figure representing a stop.

### Functions Assignable to Multifunctional Key

Next, one example of functions that can be assigned to the multifunctional key 48 will be described with reference to FIG. 33. FIG. 33 is a list of function names that can be assigned to the multifunctional key 48. It should be noted that these are merely examples, and it is also possible to assign as appropriate functions, which are not described here, to the multifunctional key 48. Hereinafter, each function shown in FIG. 33 will be described.
1. “Exposure correction”: A function of manually increasing or decreasing an exposure value with respect to a standard exposure value decided by a camera. For example, the exposure correction can be set to a value such as +1, 2, or 3 with zero as a reference.
2. “Image size”: A function of setting the number of pixels of a captured image recorded in the storage unit 91. As the number of pixels that can be set, there are VGA (640×480 (pixels)), SVGA (800×600), XGA (1024×768), SXGA (1280×960), UXGA (1600×1200), QXGA (2048×1536), and the like.
3. “Image quality mode”: A function of setting image quality of a captured image. Specifically, a function of setting a compression ratio of the captured image, setting the presence or absence of storage of uncompressed RAW data, and the like. There are a FINE mode in which the compression ratio is low and the image quality is prioritized, a NORMAL mode in which the compression ratio is high and the number of captured images is prioritized, and the like. The setting can be performed on each of these modes.
4. “RAW”: A function of setting whether or not to store RAW data, and on/off can be set.
5. “Film simulation”: A function that can change color development, contrast, tone, and the like such that a film is replaced. In the films loaded in a film camera, each film has characteristics in color tone, contrast, and the like. The film simulation function is a function of selecting a desired film mode from among a plurality of film modes set in advance to electronically realize the selection of the film corresponding to imaging intention in the digital camera, which is performed by the user in the film camera. The tone is, for example, monochrome or sepia.
6. “Grain effect”: A function that can set a strength of a granular feeling effect added to an image and a size of a grain size. With the addition of the granular feeling, a film-like texture can be produced.
7. “Color chrome effect”: A function of adjusting the tone of the image quality. Specifically, the function is to add depth to a portion with high chroma saturation, such as red, yellow, and green, and poor gradation. For example, the adjustment can be performed in a plurality of stages.
8. “Color chrome blue”: A function specialized for color chrome blue. A blue tone can be adjusted in a plurality of stages including off, for example.
9. “Smooth skin effect”: A function of expressing skin smoothness in portrait imaging. Adjustment can be performed in a plurality of stages including off.
10. “Dynamic range”: A function of setting a dynamic range which is a width of gradation expression of brightness. For example, the dynamic range can be set to standard, 2 times or 4 times the standard in a case where a standard width is 100%, and automatic adjustment. In a case where the dynamic range is widened, it is easy to suppress halation and black fullness even in a scene in which a difference between brightness and darkness is large (for example, street light imaging at night or imaging during the daytime in which both sunshine and shade are included).
11. “D range priority”: A function of performing gradation correction to suppress both halation and black fullness in a scene in which a difference between brightness and darkness is large. A plurality of stages (for example, strong and weak) can be set including off.
12. “White balance”: A function of setting white balance, which is a function of correcting the influence of a color of ambient light according to an imaging environment to image white in white. For example, since redness increases (for example, under a thick incandescent lamp) or blueness increases (sunlight during the daytime and cloudy weather) even in the case of the same white depending on a color temperature of a light source, the influence of the color temperature is corrected.
13. “Clarity”: A function of sharpening or softening an image without impairing gradation of a bright portion and a dark portion in the image. It is distinguished from “contrast” that widens a difference between brightness and darkness and “contour enhancement” that sharpens a contour of a subject.
14. “Focus area selection”: A function of selecting a position of an area to be focused in a case where a focus mode is in S or C mode. In the focus mode of S (also referred to as single AF), in a case where a shutter button is half-pushed and focusing is performed once, the focus is fixed during the half push, and the focus remains fixed even in a case where a subject is in motion. In the focus mode of C (also referred to as continuous AF), the focusing is continuously performed while the shutter button is half-pushed. In a case where the subject is in motion, the focusing is performed following the subject.
15. “Focus check”: A function of displaying a focus area on a finder in an enlarged manner in a case where a focus ring of a lens is rotated. For example, on/off can be set. Accordingly, it is easy to check whether or not the focus area is in focus.
16. “AF mode”: A function of setting a mode corresponding to a type of an area subjected to autofocusing. Examples of the type of the area include “single point”, “zone”, and “wide/tracking”. The “single point” is a mode in which pinpoint setting is performed on an area to be focused. The “zone” is a mode in which a plurality of points are collectively zoned and set as the area to be focused. The “wide/tracking” is a mode in which the entire screen is set as the area to be focused, and a subject having high contrast is focused.
17. “AF speed-up”: A function that can increase a speed of AF control. The function can be switched by on/off.
18. “Low brightness priority AF in AF-S”: A function of lengthening an exposure time in a case where AF is performed in an AF-S mode at low brightness, and on/off can be set. In a case where the function is turned on, even a dark scene can be focused at high speed.
19. “Face selection”: A function of selecting one specific person from among a plurality of subjects using a touch panel of a rear surface LCD or the like and allowing the selected person to be preferentially focused or exposed, and on/off can be set.
20. “Face detection”: A function of detecting a face of a subject and adjusting focusing and brightness on the detected face rather than a background. On/off can be set.
21. “Focus limiter”: A function of limiting a focusing distance to increase an AF speed. On/off can be set.
22. “Focus check lock”: A function of maintaining the display in an enlarged manner in a case where the motion picture capturing is started during the display of the focus area in an enlarged manner in the “focus check” described above. On/off can be set.
23. “Self-timer”: A function of causing a shutter to automatically operate after a lapse of a certain period of time. On/off setting and on time setting can be made.
24. “AE bracketing setting”: A function of continuously capturing a plurality of photographs while changing an exposure value by a single shutter operation. On/off can be set, and the exposure value to be changed can also be set.
25. “Focus BKT (bracketing) setting”: A function of continuously capturing a plurality of photographs while changing a focus position by a single shutter operation.
26. “Photometry”: A function of switching a plurality of types of photometry modes having different photometry areas to be adjusted to appropriate exposure. Examples of the selectable photometry mode include spot photometry in which a small region in a screen center is used as the photometry area, and multi-photometry in which a camera automatically decides the photometry area from a plurality of areas based on information such as brightness, color, and background.
27. “Shutter method”: A function of setting a shutter method selected from among a mechanical shutter, an electronic shutter, or a combination of the mechanical shutter and the electronic shutter.
28. “Flicker reduction”: A function of reducing the influence of a flicker phenomenon which is flicker of brightness due to blinking of illumination. On/off can be set, and in a case where the function is turned on, it is possible to perform imaging at a timing at which the influence of the flicker phenomenon is small.
29. “Sensitivity”: A function of setting a sensitivity (ISO sensitivity or the like) of an image sensor. The sensitivity can be selected from values set in advance, in addition to auto.
30. “Shake prevention mode”: A function of setting a mode in which a camera shake and a subject shake are reduced. As an example, the shutter speed is controlled to prevent shaking. The mode includes a mode in which the shake prevention is constantly operated, a mode in which the shake prevention is operated in a case where a moving subject is recognized, and the like.
31. “35 mm format mode”: A mode in which an imaging angle of view is set to an angle of view of a 35 mm film. On/off can be set.
32. “Wireless communication”: A function of setting wireless communication with a device such as a smartphone. On/off and the like can be set.
33. “Flash function setting”: A function of setting an operation mode of a flash. A light emission amount is corrected by automatic light adjustment according to an amount of subject light incident via a lens.
34. “TTL-LOCK”: A function of locking a calculation result by pre-light emission in order to make a light emission amount of a flash constant in a plurality of imaging operations through the lens (TTL) light emission. On/off can be set, and in a case where the function is turned on, it is possible to keep the imaging condition and dimming.
35. “Modeling light emission”: A function that can check shadow appearance of a subject by the pre-light emission. On/off can be set.
36. “Motion picture crop ratio fixing mode”: A function of fixing a crop ratio, which is a ratio of a focal length in motion picture capturing to a focal length in still picture capturing. The angle of view can be kept constant even in a case where the motion picture mode is changed. On/off can be set. For example, in a case where a resolution is high or a frame rate is large, processing of the motion picture cannot catch up, and thus, in some cases, a part of an imaging range is cropped (cut out) and processed. However, in a case where the crop ratio is changed, the angle of view is also changed. For this case, this function is for making the angle of view constant.
37. “Shake prevention mode boost”: A function of setting strength of camera shake correction. For example, on/off can be set.
38. “Zebra setting”: a function of displaying a stripe zebra pattern in a high-brightness portion in which halation is likely to occur due to overexposure on a live view display screen in the motion picture mode to call the user's attention. On/off can be set.
39. “Internal/external microphone level setting”: A function of setting a sound collection level of a microphone.
40. “motion picture-dedicated operation mode”: A function of setting an operation method dedicated to a motion picture in order to suppress a camera operation sound in a case where the motion picture is captured. On/off can be set.
41. “Sub-liquid crystal monitor switching”: A function of setting a display content of a sub monitor (top surface LCD).
42. “Depth-of-field checking”: A function of setting whether or not to display a depth of field on a main monitor (rear surface LCD or EVF). On/off can be set.
43. “Manual monitor exposure/WB reflection”: A function of reflecting the exposure and the white balance of the image sensor on the display of the main monitor (rear surface LCD or EVF) in manual imaging in which the exposure and the white balance are manually set. For example, on/off can be set.
44. “Natural live view”: A function of correcting the tint and the gradation of the image displayed on the EVF such that a subject displayed on the EVF is easily viewed. On/off can be set.
45. “Histogram”: A function of displaying, on the main monitor (rear surface LCD or EVF), a histogram showing a distribution of pixel values from a bright portion (highlight) to a dark portion (shade) of a captured image, in which the brightness of each pixel in the captured image is assigned to a horizontal axis and the number of pixels is assigned to a vertical axis. On/off can be set.
46. “Electronic level”: A function of displaying, on the EVF, an electronic level indicating an inclination of a camera body with respect to the horizontal. On/off can be set.
47. “Information display enlargement mode”: A function of enlarging a display size of information displayed on a monitor, such as the rear surface LCD, the top surface LCD, and the EVF. On/off can be set.
48. “Only AE LOCK”: A function of fixing an exposure value with a pushing-down operation of the multifunctional key. On/off can be set.
49. “Only AF LOCK”: A function of fixing a focus with a pushing-down operation of the multifunctional key. On/off can be set.
50. “AE/AF LOCK”: A function of fixing an exposure value and a focus with a pushing-down operation of the multifunctional key. On/off can be set. For example, the function is used in a case where a subject is disposed at an end of a screen and imaging is performed. It is possible to change the composition with movement of the camera in a state where locking is performed with the subject at the end and then the shutter is half-pushed.
51. “AF-ON”: A function of setting whether or not to operate autofocus. The function is used for switching to manual focus.
52. “Only AWB LOCK”: A function of locking, in a case where AWB for automatically adjusting white balance is turned on, a state adjusted by the AWB with a pushing-down operation of the multifunctional key.
53. “Shutter speed lock”: A function of locking, in a case where imaging is performed with stop priority (mode in which a stop is fixed and exposure is adjusted with shutter speed), a shutter speed during a pushing-down operation of the multifunctional key.
54. “Lock designation”: A function of designating a target to be locked among operation buttons or functions of a camera in order to prevent an erroneous operation. Locking of all functions or some functions can be set.
55. “Post-imaging automatic image transfer”: A function of automatically transferring a captured image to a paired terminal. On/off can be set.
56. “Pairing connection destination selection”: A function of selecting a connection destination to be paired.
57. “Bluetooth ON/OFF”: A function of turning on and off a communication function of a Bluetooth (registered trademark) standard.
58. “Quick menu”: A function of checking or resetting imaging setting.
59. “Playback mode”: A function of switching to a playback mode in which a captured image is played back. On/off can be set.
60. “None”: No function can be assigned to the multifunctional key.

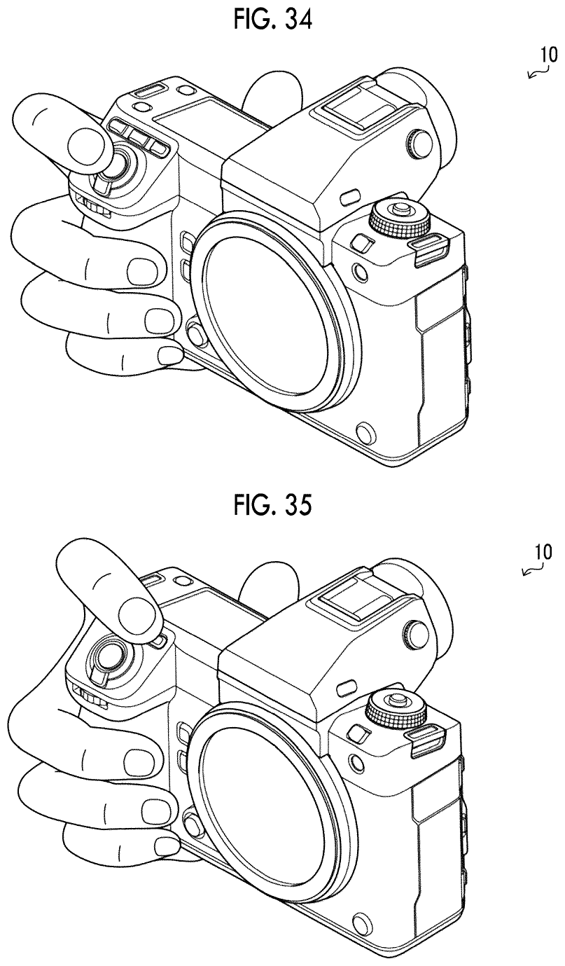

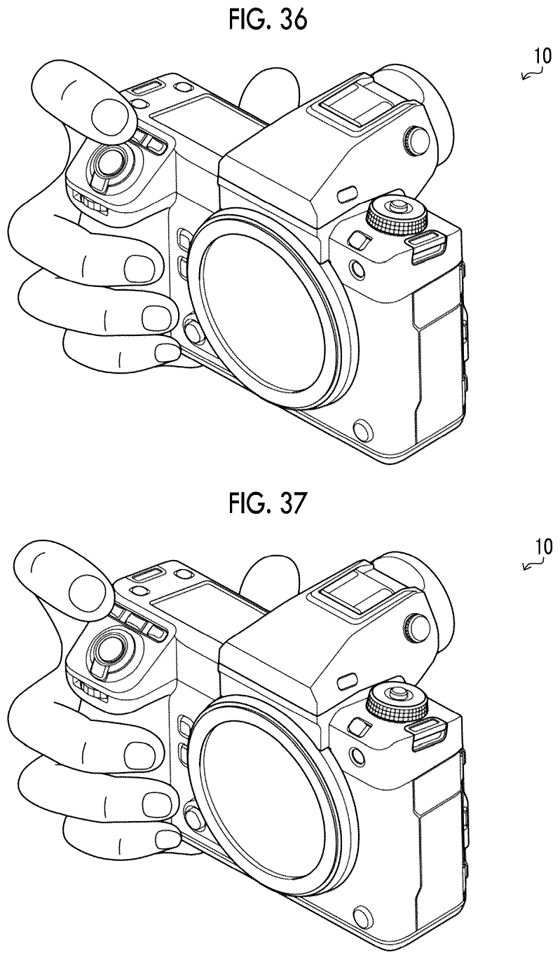

FIGS. 34 to 37 show examples of use aspects of the camera 10 according to the present embodiment. FIG. 34 is a diagram showing a state where the user pushes down the release button 41 with an index finger in a state where the grip portion 16 of the camera 10 shown in FIG. 1 is gripped by the right hand. Similarly, FIG. 35 shows a state where the multifunctional key 48A is pushed down, FIG. 36 shows a state where the multifunctional key 48B is pushed down, and FIG. 37 shows a state where the multifunctional key 48C is pushed down. As shown in FIGS. 34 to 37, with the camera 10 according to the present embodiment, it is possible to operate the release button 41 and the plurality of multifunctional keys 48A to 48C with movement of only a finger (index finger in FIGS. 34 to 37) while gripping the grip portion 16.

In this manner, with the movement of the finger of the hand gripping the grip portion 16, it is possible to operate the release button 41 and the plurality of multifunctional keys 48, respectively. Therefore, complicated operations of fingers and the visual line are no longer necessary, and it is possible to realize good operability. Further, with the unnecessity of the complicated operations of the fingers and the visual line, the user can perform smooth imaging at a desired timing. That is, with the camera 10 according to the present embodiment, it is possible to achieve both operability and fastness.

Further, in the above embodiment, for example, as a hardware structure of a processing unit that executes various processing such as the reception unit 60, the assignment unit 62, and the controller 64, the following various processors may be used. As described above, in addition to the CPU that is a general-purpose processor that executes software (program) to function as various processing units, the various processors include a programmable logic device (PLD) that is a processor of which a circuit configuration can be changed after manufacture, such as a field programmable gate array (FPGA), and a dedicated electric circuit that is a processor having a circuit configuration that is designed for exclusive use in order to execute a specific process, such as an application specific integrated circuit (ASIC).

One processing unit may be configured by one of the various processors or a combination of two or more processors of the same type or different types (for example, a combination of a plurality of FPGAs or a combination of a CPU and an FPGA). Further, the plurality of processing units may be configured of one processor.

As an example of configuring the plurality of processing units with one processor, first, there is a form in which one processor is configured by a combination of one or more CPUs and software and the processor functions as the plurality of processing units, as represented by computers such as a client and a server. Second, as represented by a system on chip (SoC) or the like, there is a form in which the processor is used in which the functions of the entire system which includes the plurality of processing units are realized by a single integrated circuit (IC) chip. In this manner, the various processing units are configured using one or more of the various processors as a hardware structure.

Further, more specifically, a circuitry combining circuit elements such as semiconductor elements can be used as the hardware structure of the various processors.

Further, in the above embodiment, the form has been described in which various programs in the imaging apparatus are stored (installed) in the storage unit 91 in advance, but the present disclosure is not limited thereto. The various programs in the imaging apparatus may be provided in a form of being recorded in a recording medium, such as a compact disc read only memory (CD-ROM), a digital versatile disc read only memory (DVD-ROM), and a universal serial bus (USB) memory. Further, a form may be employed in which the various programs in the imaging apparatus are downloaded from an external apparatus via the network. Furthermore, the technique of the present disclosure extends to a storage medium that stores the program non-transitorily, in addition to the program.

In the technique of the present disclosure, the embodiment and the examples described above can be combined as appropriate. The above-described contents and the above-shown contents are detailed descriptions for parts according to the technique of the present disclosure, and are merely examples of the technique of the present disclosure. For example, the descriptions regarding the configurations, the functions, the actions, and the effects are descriptions regarding an example of the configurations, the functions, the actions, and the effects of the part according to the technique of the present disclosure. Accordingly, in the contents described and the contents shown hereinabove, it is needless to say that removal of an unnecessary part, or addition or replacement of a new element may be employed within a range not departing from the gist of the technique of the present disclosure.

Regarding the above embodiment, the following Supplementary Notes are further disclosed.

### Supplementary Note 1

An imaging apparatus including a main body having a front surface on which an imaging lens is provided, a rear surface facing the front surface, and a top surface connecting the front surface and the rear surface,
in which a release button, a display, and a plurality of switches are disposed on the top surface, the imaging apparatus comprising:
a processor configured to perform control of displaying, along a predetermined side forming a contour of the display, pieces of information indicating functions assigned to the plurality of switches side by side in a disposition order of the plurality of switches.

### Supplementary Note 2

The imaging apparatus according to Supplementary Note 1, wherein the side extends in a direction intersecting a normal direction of a projection plane of the front surface and a normal direction of a projection plane of the top surface.

### Supplementary Note 3

The imaging apparatus according to Supplementary Note 1 or 2,
wherein the side, among a plurality of sides forming the contour of the display, is relatively closer to the plurality of switches than other sides.

### Supplementary Note 4

The imaging apparatus according to any one of Supplementary Notes 1 to 3,
wherein a straight line that passes through a center of an entirety of the plurality of switches in a direction along the side and is orthogonal to the direction along the side intersects the display.

### Supplementary Note 5

The imaging apparatus according to any one of Supplementary Notes 1 to 4,
wherein a straight line that passes through a center of an entirety of the plurality of switches in a direction along the side and is orthogonal to the direction along the side intersects the release button.

### Supplementary Note 6

The imaging apparatus according to any one of Supplementary Notes 1 to 5,
wherein the plurality of switches are sequentially disposed in parallel to a direction along the side.

### Supplementary Note 7

The imaging apparatus according to any one of Supplementary Notes 1 to 6,
wherein the display has a rectangular shape.

### Supplementary Note 8

The imaging apparatus according to any one of Supplementary Notes 1 to 7,
wherein the main body has a grip portion in which a part of the front surface protrudes,
the top surface includes an upper surface of the grip portion and an upper surface other than the grip portion, and
at least one of the plurality of switches is disposed on the upper surface of the grip portion.

### Supplementary Note 9

The imaging apparatus according to Supplementary Note 8,
wherein the upper surface of the grip portion and the upper surface other than the grip portion are surfaces that are both visible in a case of being viewed from a normal direction of a projection plane of the top surface.

### Supplementary Note 10

The imaging apparatus according to Supplementary Note 8 or 9,
wherein the upper surface of the grip portion is inclined in a direction in which a height decreases from a side of the rear surface toward a side of the front surface, or a height of the upper surface of the grip portion is lower than a height of the upper surface other than the grip portion on the side of the rear surface.

### Supplementary Note 11

The imaging apparatus according to any one of Supplementary Notes 1 to 10,
wherein the processor is configured to perform control of displaying, on the display, a predetermined figure for each function as information indicating the function.

### Supplementary Note 12

The imaging apparatus according to Supplementary Note 11,
wherein the processor is configured to perform control of displaying, on the display, the figure having a shape corresponding to a shape of each of the plurality of switches.

### Supplementary Note 13

The imaging apparatus according to Supplementary Note 11 or 12,
wherein the processor is configured to perform control of displaying, on the display, the figure having a shape corresponding to a magnitude relationship between a length of the switch in a direction along the side and a length of the switch in a direction intersecting the direction along the side.

### Supplementary Note 14

The imaging apparatus according to any one of Supplementary Notes 1 to 13,
wherein the processor is configured to perform, in a case where the switch is operated, control of causing a display form of the information indicating the function corresponding to the operated switch to be different.

### Supplementary Note 15

The imaging apparatus according to any one of Supplementary Notes 1 to 14,
wherein the switch is a multifunctional key whose function to be assigned is changeable.

### Supplementary Note 16

The imaging apparatus according to Supplementary Note 15,
wherein the processor is configured to receive, for each switch, selection of at least one of a plurality of predetermined functions to be assignable.

### Supplementary Note 17

The imaging apparatus according to Supplementary Note 16,
wherein the processor is configured to:
specify, for each switch, the function that is selected a large number of times after the selection is received a plurality of times; and
assign the specified function to the switch.

### Supplementary Note 18

The imaging apparatus according to any one of Supplementary Notes 15 to 17,
wherein the imaging apparatus has a plurality of switchable operation modes,
functions different for respective operation modes are assigned to the switch, and
the processor is configured to perform control of displaying, on the display, the information indicating the function corresponding to the set operation mode.

### Supplementary Note 19

A control method executed by a computer, in an imaging apparatus including a main body having a front surface on which an imaging lens is provided, a rear surface facing the front surface, and a top surface connecting the front surface and the rear surface,
in which a release button, a display, and a plurality of switches are disposed on the top surface, the control method comprising:
performing control of displaying, along a predetermined side of the display, pieces of information indicating functions assigned to the plurality of switches side by side in a disposition order of the plurality of switches.

### Supplementary Note 20

A control program causing a computer to execute a process, in an imaging apparatus including a main body having a front surface on which an imaging lens is provided, a rear surface facing the front surface, and a top surface connecting the front surface and the rear surface,
in which a release button, a display, and a plurality of switches are disposed on the top surface, the control program comprising:
performing control of displaying, along a predetermined side of the display, pieces of information indicating functions assigned to the plurality of switches side by side in a disposition order of the plurality of switches.

What is claimed is:

1. An imaging apparatus including a main body having:
a front surface on which an imaging lens is provided;
a rear surface facing the front surface; and
a top surface connecting the front surface and the rear surface,
in which a release button, a display, and a plurality of switches are disposed on the top surface,
the imaging apparatus comprising a processor configured to perform control of displaying, along a predetermined side forming a contour of the display, pieces of information indicating functions assigned to the plurality of switches side by side in a disposition order of the plurality of switches.

2. The imaging apparatus according to claim 1, wherein the predetermined side extends in a direction intersecting a normal direction of a projection plane of the front surface and a normal direction of a projection plane of the top surface.

3. The imaging apparatus according to claim 1, wherein the predetermined side, among a plurality of sides forming the contour of the display, is relatively closer to the plurality of switches than other sides.

4. The imaging apparatus according to claim 1, wherein a straight line that passes through a center of an entirety of the plurality of switches in a direction along the predetermined side and is orthogonal to the direction along the predetermined side intersects the display.

5. The imaging apparatus according to claim 1, wherein a straight line that passes through a center of an entirety of the plurality of switches in a direction along the predetermined side and is orthogonal to the direction along the predetermined side intersects the release button.

6. The imaging apparatus according to claim 1, wherein the plurality of switches are sequentially disposed in parallel to a direction along the predetermined side.

7. The imaging apparatus according to claim 1, wherein the display has a rectangular shape.

8. The imaging apparatus according to claim 1, wherein:
the main body has a grip portion in which a part of the front surface protrudes,
the top surface includes an upper surface of the grip portion and an upper surface other than the grip portion, and
at least one of the plurality of switches is disposed on the upper surface of the grip portion.

9. The imaging apparatus according to claim 8, wherein the upper surface of the grip portion and the upper surface other than the grip portion are surfaces that are both visible in a case of being viewed from a normal direction of a projection plane of the top surface.

10. The imaging apparatus according to claim 8, wherein the upper surface of the grip portion is inclined in a direction in which a height decreases from a side of the rear surface toward a side of the front surface, or a height of the upper surface of the grip portion is lower than a height of the upper surface other than the grip portion on the side of the rear surface.

11. The imaging apparatus according to claim 1, wherein the processor is configured to perform control of displaying, on the display, a predetermined figure for each function as information indicating the function.

12. The imaging apparatus according to claim 11, wherein the processor is configured to perform control of displaying, on the display, the figure having a shape corresponding to a shape of each of the plurality of switches.

13. The imaging apparatus according to claim 11, wherein the processor is configured to perform control of displaying, on the display, the figure having a shape corresponding to a magnitude relationship between a length of the switch in a direction along the predetermined side and a length of the switch in a direction intersecting the direction along the predetermined side.

14. The imaging apparatus according to claim 1, wherein the processor is configured to perform, in a case where the switch is operated, control of causing a display form of the information indicating the function corresponding to the operated switch to be different.

15. The imaging apparatus according to claim 1, wherein the switch is a multifunctional key whose function to be assigned is changeable.

16. The imaging apparatus according to claim 15, wherein the processor is configured to receive, for each switch, selection of at least one of a plurality of predetermined functions to be assignable.

17. The imaging apparatus according to claim 16, wherein the processor is configured to:
specify, for each switch, the function that is selected a large number of times after the selection is received a plurality of times; and
assign the specified function to the switch.

18. The imaging apparatus according to claim 15, wherein:
the imaging apparatus has a plurality of switchable operation modes,
functions different for respective operation modes are assigned to the switch, and
the processor is configured to perform control of displaying, on the display, the information indicating the function corresponding to the set operation mode.

19. A control method executed by a computer, in an imaging apparatus including a main body having:
a front surface on which an imaging lens is provided;
a rear surface facing the front surface; and
a top surface connecting the front surface and the rear surface,
in which a release button, a display, and a plurality of switches are disposed on the top surface,
the control method comprising performing control of displaying, along a predetermined side of the display, pieces of information indicating functions assigned to the plurality of switches side by side in a disposition order of the plurality of switches.

20. A non-transitory computer-readable storage medium storing a control program causing a computer to execute a process, in an imaging apparatus including a main body having:
a front surface on which an imaging lens is provided;
a rear surface facing the front surface; and
a top surface connecting the front surface and the rear surface,
in which a release button, a display, and a plurality of switches are disposed on the top surface,
the control program comprising performing control of displaying, along a predetermined side of the display, pieces of information indicating functions assigned to the plurality of switches side by side in a disposition order of the plurality of switches.
